(19) United States
(12) Patent Application Publication
(10) Pub. No.: US 2015/0214581 A1
(43) Pub. Date: Jul. 30, 2015

(54) BATTERY SYSTEM HAVING A PLURALITY OF BATTERY CELLS AND A BATTERY MANAGEMENT SYSTEM

(71) Applicant: Robert Bosch GmbH, Stuttgart (DE)

(72) Inventors: Johannes Federle, Rottenburg (DE); Michael Steil, Korntal-Muenchingen (DE); Sarmimala Hore, Stuttgart (DE)

(21) Appl. No.: 14/607,518

(22) Filed: Jan. 28, 2015

(30) Foreign Application Priority Data
Jan. 28, 2014 (DE) 10 2014 201 484.0

(51) Int. Cl. H01M 10/42; H01M 10/48; H01M 2/12; H01M 2/20

(52) U.S. Cl. CPC H01M 10/425; H01M 2/206; H01M 10/48; H01M 2/12; H01M 2220/20; H01M 2010/4271

(57) ABSTRACT

A battery system (1) having a plurality of battery cells (2) and a battery management system (14) for monitoring and regulating the battery system (1), wherein the battery cells (2) are electrically connected to one another, and at least one battery cell (2) of the battery system (1) is electrically connected to the battery management system (14) in order to detect at least one battery cell parameter. In this case, the battery system (1) comprises at least one printed circuit board (3) having at least one high-current line region and at least one low-current line region, wherein the battery cells (2) of the battery system (1) are electrically connected to one another via the at least one high-current line region, and the at least one battery cell (2) is electrically connected to the battery management system (14) via the at least one low-current line region.

### BACKGROUND OF THE INVENTION

The invention relates to a battery system having a plurality of battery cells and a battery management system for monitoring and regulating the battery system, wherein the battery cells are electrically connected to one another and at least one battery cell of the battery system is electrically connected to the battery management system in order to detect at least one battery cell parameter.

Battery systems of this kind are known, for example, from prior art documents US 2010/0052692 A1, US 2012/0259567 A1 or EP 2 352 186 A1. In particular, battery systems of this kind are used in hybrid vehicles, plug-in hybrid vehicles or electric vehicles for providing the electrical energy required for operation. In order to achieve the power and energy data required for operating the drive motor of a hybrid vehicle, plug-in hybrid vehicle or electric vehicle, a relatively large number of individual battery cells are usually electrically connected in parallel or in series. Particularly in the case of battery systems which are used in electric vehicles, 96 or more battery cells may be connected in series and/or in parallel in order to achieve a total voltage of the battery system of 450 V.

It is known, in particular, to use what are known as cell connectors, which are electrically conductively connected to the cell terminals of the battery cells, in order to connect the battery cells of a battery system. It is known, in particular, to connect cell connectors to the cell terminals of the battery cell by means of screw connections or welded connections.

Since the battery cells of a battery system can usually be safely and reliably operated only under certain ambient conditions, battery systems usually have a battery management system for monitoring and regulating the battery system, in particular for monitoring and regulating the battery cells of the battery system. In this case, a battery management system may comprise, in particular, what are known as Cell Supervision Circuits (CSC) as cell monitoring units which detect, for example, the battery cell voltages and/or the battery cell temperatures of the battery cells as battery cell parameters. Furthermore, a battery management system usually comprises a control unit, in particular what is known as a Battery Control Unit (BCU) which usually evaluates the battery cell parameters which are detected by the cell monitoring units. In order to detect said battery cell parameters, at least some of the battery cells of a battery system are electrically connected to the battery management system. A large number of electrical cables are generally required for this purpose. In this case, the electrical connection both of the battery cells to one another and also of the battery cells to the battery management system is complex and cannot be carried out, or is difficult to carry out, in an automated manner. Therefore, connection of the battery cells to one another and connection of the battery cells to the battery management system are therefore usually associated with high costs.

For this reason, attempts are being made to reduce the connection complexity. For example, document DE 10 2011 109 249 A1 discloses a high-voltage battery for vehicle applications having a large number of battery cells which are connected to one another, wherein the battery cells are electrically connected to a cell connector printed circuit. As a result, the connection complexity in respect of the connection of the battery cells to one another is already reduced. Furthermore, document DE 10 2006 06 270 A1 discloses providing a printed circuit board which comprises electronic components for monitoring battery cells of a battery module. In order to connect the battery cells to one another, cell connectors are provided in this case, as before. However, contact can be made with cell connectors directly by the printed circuit board.

### SUMMARY OF THE INVENTION

Against this background, the object of the invention is to improve a battery system having a plurality of battery cells and a battery management system, in particular to the effect that the electrical connection of the battery cells to one another and also the electrical connection of the battery cells to the battery management system are simplified, preferably in such a way that the corresponding electrical connection is carried out or can be carried out in an automated manner.

In order to achieve the object, a battery system having a plurality of battery cells and a battery management system for monitoring and regulating the battery system, wherein the battery cells are electrically connected to one another, and at least one battery cell of the battery system is electrically connected to the battery management system in order to detect at least one battery cell parameter, is proposed, wherein the battery system comprises at least one printed circuit board having at least one high-current line region and at least one low-current line region, wherein the battery cells are electrically connected to one another via the at least one high-current line region, and the at least one battery cell is electrically connected to the battery management system via the at least one low-current line region. In this case, provision is made, in particular, for the high-current line region to be designed to couple in and/or to transmit high electrical powers. To this end, the high-current line region advantageously comprises line elements, in particular conductor tracks, wherein the line elements preferably have a thickness of at least 500 μm. Provision is made, in particular, for the high-current line region to have line elements with a current-carrying capacity of up to 1000 A and a cross section of more than 20 mm2. Furthermore, provision is made, in particular, for the low-current line region to be designed to couple in and/or to transmit low electrical powers. To this end, the low-current line region advantageously comprises line elements, in particular conductor tracks, wherein the line elements preferably do not exceed a thickness of 100 μm. The term “high current” denotes, in particular, the useful current of the battery system comprising the battery cells or relates, in particular, to the useful current provided by the battery cells during discharge of the battery cells and/or the charge current supplied during charging of the battery cells,

Complex cabling for connecting the battery cells to one another and for connecting the battery cells to the battery management system for detecting battery cell parameters is advantageously dispensed with in particular owing to the integration of the high-current line region and the low-current line region in a printed circuit board. A printed circuit board having at least one high-current line region and at least one low-current line region can additionally advantageously be produced in an automated manner, so that the electrical connection of the battery cells to one another and also the electrical connection of at least one battery cell of the battery system to the battery management system for detecting at least one battery cell parameter can be performed in an at least partially automated manner.

In addition, the power and control electronics of the battery system are advantageously integrated into the at least one printed circuit board, as a result of which the required installation space is advantageously reduced. Furthermore, a cost saving can advantageously be achieved as a result.

Provision is made, in particular, for the battery cells of the battery system to be secondary battery cells, that is to say rechargeable battery cells which can be recharged. The battery cells are preferably lithium-ion cells. Furthermore, provision is made, in particular, for the battery system according to the invention to be designed to provide the energy required for the operation of a hybrid vehicle, plug-in hybrid vehicle or electric vehicle.

According to one advantageous refinement of the battery system according to the invention, the printed circuit board has contact-making elements which are electrically connected to one another and on which the battery cells are arranged, wherein the battery cells are in each case connected to the at least one high-current line region and/or the at least one low-current line region via the contact-making elements. The connection of the battery cells to one another is advantageously determined by the connection of the contact-making elements of the printed circuit board. In this case, provision is made, in particular, for the battery cells to be electrically connected to one another in series and/or in parallel by appropriate arrangement on the contact-making elements, in particular in what is known as an MsNp configuration. In an MsNp configuration of this kind, a number N of battery cells is in each case connected electrically in parallel and in the process form a subunit, wherein a number M of said subunits is connected electrically in series.

Provision is made, in particular, for the battery cells to each have contact-making elements, in particular a first contact-making element, which is electrically conductively connected to a first electrode of the battery cell, and a second contact-making element, which is electrically conductively connected to a second electrode of the battery cell. Provision is made, in particular, for the battery cell to have at least one further contact-making element via which contact can be made in an electrically conductive manner with, in particular, a sensor for detecting at least one battery cell parameter. In this case, a sensor of this kind may be, in particular, a temperature sensor for detecting the battery cell temperature of the battery cell. In this case, the sensor is preferably connected to the low-current line region via the contact-making elements of the printed circuit board, in particular in order to transmit detected measurement values to the battery management system of the battery system.

The contact-making elements of the battery cells are preferably each in the form of a contact lug or contact pin in this case. Provision is made, in particular, for the contact-making elements of the battery cells to not be of rigid design. According to one advantageous refinement of the invention, the contact-making elements of the battery cells are each produced by means of a deep-drawing process. The contact-making elements of the battery cells are preferably connected to the contact-making elements of the printed circuit board via a plug connection. The contact-making elements of the battery cells and the contact-making elements of the printed circuit board advantageously form contact-making pairs in this case, wherein one contact-making element of a contact-making pair surrounds the other contact-making element of the contact-making pair, preferably in a spring-loaded manner, advantageously in such a way that the battery cell is connected in a releasable manner to the printed circuit board by contact being made.

One advantageous development of the battery system according to the invention makes provision for the printed circuit board to have receiving regions in which the contact-making elements are arranged in each case, wherein the battery cells are in each case inserted at least partially into the receiving regions, preferably in an interlocking manner. Provision is made, in particular, for the receiving regions to be in the form of recesses or cutouts in the printed circuit board. In this case, the receiving regions advantageously surround the battery cells at least partially. When arranged on the contact-making elements of the printed circuit board, the battery cells are advantageously, as it were, positively guided by the receiving regions. As a result, contact is advantageously made with the battery cells by the contact-making elements of the printed circuit board in a simplified manner.

Provision is particularly preferably made for the at least one printed circuit board of the battery system according to the invention to be a high-current printed circuit board. High-current printed circuit boards are known from the prior art, for example from document EP 1 639 869 B1. Provision may be made, in particular, for the at least one printed circuit board to be a printed circuit board which is disclosed in said document. In this case, line elements and/or electronic components can advantageously be integrated into the printed circuit board in a simple manner via receiving regions which are correspondingly provided in the printed circuit board for this purpose, and in the process can be electrically connected via the high-current line region and/or the low-current line region.

According to a further advantageous variant refinement of the invention, the at least one high-current line region comprises cell connectors, wherein the battery cells of the battery system are electrically connected to one another by means of the cell connectors. In particular, provision is made as an advantageous variant refinement of the invention for the cell connectors to be the contact-making elements of the printed circuit board. The cell connectors are preferably in the form of stamped and/or bent parts. In this case, provision is made, in particular, for the cell connectors to be integrated into the at least one printed circuit board via corresponding receiving regions of the at least one printed circuit board. In this case, the cell connectors advantageously project beyond the printed circuit board, as a result of which the connection of the cell connectors to the cell terminals of the battery cells, in particular by welding, is particularly simple and can advantageously be carried out in an automated manner. In addition, provision is made, as an advantageous development of the invention, for further contact elements, such as connection plugs for example, to correspondingly protrude beyond the printed circuit board, so that particularly simple connection of said contact elements is possible.

In a further particularly advantageous refinement of the invention, the battery cells of the battery system are electrically connected to one another to form at least one battery module, wherein the at least one printed circuit board is arranged on the at least one battery module. As a result, contact can advantageously be made with the battery cells by the at least one printed circuit board in a particularly simple manner. According to a particularly preferred refinement of the invention, provision is made in this case for the printed circuit board which is to be arranged on a battery module to be integrated in a battery module cover or to be in the form of a battery module cover, as a result of which contact can be made with the printed circuit board by the at least one battery module in a particularly simple manner, and the connection complexity is low.

In particular, owing to the cell connectors which project beyond the printed circuit board and are preferably of plastically deformable design, contact can be made with the cell connectors by the battery cells in a particularly simple manner, in particular by automated welding of the protruding ends of the cell connectors to the cell terminals of the battery cells. In this way, contact can advantageously be made with the cell connectors by the battery cells in an automated manner even when the cell terminals of battery cells, which are arranged next to one another, of a battery module have different heights, this possibly being the result of, in particular, the battery cells of a battery module usually being arranged on a heat sink for controlling the temperature of the battery cells for the purpose of achieving a good contact-making connection.

A further particularly advantageous refinement of the invention makes provision for the battery management system to be at least partially integrated into the at least one printed circuit board. In particular, electronic components of the battery management system are already integrated into the at least one printed circuit board, in particular into the low-current line region, in this case. In particular, provision is further made for high-current and/or signal lines of the battery management system to be integrated into the at least one printed circuit board. In this case, the signal lines are preferably integrated in the low-current line region. In addition, heat-conducting plates, for example copper layers, for dissipating heat into the at least one printed circuit board are advantageously integrated into the at least one printed circuit board. Therefore, in particular, the electronic components which are integrated into the at least one printed circuit board are advantageously protected against overheating in an improved manner. These heat-conducting plates advantageously project beyond the printed circuit board for further improved heat dissipation. In this case, contact is preferably made with the heat-conducting plates by a cooling apparatus, in particular the cooling apparatus which is provided to control the temperature of the battery cells.

According to a further advantageous refinement of the battery system according to the invention, provision is made for the battery management system to comprise at least one cell monitoring unit, wherein the at least one cell monitoring unit is integrated into the at least one printed circuit board. In this case, the at least one cell monitoring unit serves, in particular, to detect at least one battery cell parameter. Provision is made, in particular, for the at least one cell monitoring unit to detect the battery cell voltage of at least one battery cell and/or the battery cell temperature of at least one battery cell. Provision is made, in particular, for in each case one cell monitoring unit to be associated with at least one battery module. Provision is particularly preferably made for the cell monitoring unit to be in the form of what is known as a Cell Supervision Circuit. In particular, the cell monitoring unit can be integrated into the at least one printed circuit board as an application-specific integrated circuit (ASIC, ASIC: Application Specific Integrated Circuit).

A further advantageous refinement of the invention makes provision for the battery management system to comprise at least one control unit, wherein the at least one control unit is integrated into the at least one printed circuit board. In this case, the at least one control unit can be in the form of, in particular, a microcontroller circuit which is integrated into the at least one printed circuit board. The at least one control unit is preferably in the form of a Battery Control Unit (BCU). In this case, the at least one control unit is advantageously designed to evaluate the battery cell parameters which are detected by the at least one cell monitoring unit. To this end, the at least one control unit is preferably connected to the at least one cell monitoring unit via at least one signal line. In this case, the signal line is preferably in the form of a conductor track of the at least one printed circuit board. Transmission of the battery cell parameters from a plurality of cell monitoring units to the at least one control unit can be performed, in particular, in accordance with what is known as the daisy chain principle.

According to a further advantageous refinement of the invention, the battery management system comprises at least one sensor for detecting at least one battery cell parameter, wherein the at least one sensor is integrated into the at least one printed circuit board and/or is connected to the at least one control unit of the battery management system via the at least one printed circuit board. The at least one sensor is preferably a temperature sensor and/or a pressure sensor and/or a current sensor. The at least one battery cell parameter is advantageously detected by measurement by the at least one sensor and transmitted to the at least one cell monitoring unit, advantageously via a signal line which is in the form of a conductor track of the at least one printed circuit board, in particular in the low-current line region of the printed circuit board.

In a further advantageous refinement of the battery system according to the invention, the at least one printed circuit board comprises at least one interface for making electrically conductive contact with the at least one high-current line region and/or the at least one low-current line region. Electrically conductive contact can preferably be made by a further printed circuit board of a further battery module via the at least one interface. Furthermore, provision is made for the electrically conductive contact to be made with an external device, for example for contact to be made with a vehicle controller, in particular what is known as a Vehicle Control Unit (VCU), via the at least one interface. In this case, the connection complexity is advantageously further reduced by the interface.

According to a further particularly advantageous refinement of the invention, the battery system comprises a degassing device for discharging a fluid which is released by a battery cell of the battery system, battery cells of the battery system being connected to said degassing device via connection elements, wherein the at least one printed circuit board has cutouts through which the connection elements are guided. In this case, the battery cells of the battery system preferably have degassing openings, in particular degassing openings which are closed by a safety valve, via which the fluid which is formed within the battery cell can escape when a specific battery cell internal pressure is exceeded. In this case, the fluid can advantageously flow into the degassing device via the respective connection element which is guided through the corresponding cutouts in the printed circuit board. Provision is made, in particular, for the degassing device to be a degassing collector. Provision is particularly preferably made for the printed circuit board to be in the form of a cover which is arranged on the battery cells of the battery system in this case. In particular, provision is made, as an advantageous development of the invention, for the printed circuit board and the degassing collector to be integrated into a battery module cover, wherein the battery module cover is arranged in each case on the battery cells of the battery system which are to be connected to one another to form a battery module.

A further advantageous refinement of the invention makes provision for at least the printed circuit board and the battery cells of the battery system to be arranged in a housing, preferably as a module unit of the battery system. In this case, cooling means, in particular means for cooling the battery cells and/or the electronics components of the printed circuit board, are advantageously arranged in the housing and/or on the housing. In particular, an air cooling system and/or a liquid cooling system are/is provided.

### BRIEF DESCRIPTION OF THE DRAWINGS

Further advantageous details, features and refinement details of the invention are explained in greater detail in connection with the exemplary embodiments which are illustrated in the figures, in which:

FIG. 1 is a schematic illustration of a plan view of an exemplary embodiment of a battery system according to the invention;

FIG. 2 is a schematic illustration of a plan view of an exemplary embodiment for a printed circuit board which is intended to be used with a battery system according to the invention;

FIG. 3 is a schematic illustration of a section through a further exemplary embodiment for a printed circuit board which is intended to be used with a battery system according to the invention; and

FIG. 4 is a schematic illustration of a further exemplary embodiment for a printed circuit board of a battery system according to the invention.

### DETAILED DESCRIPTION

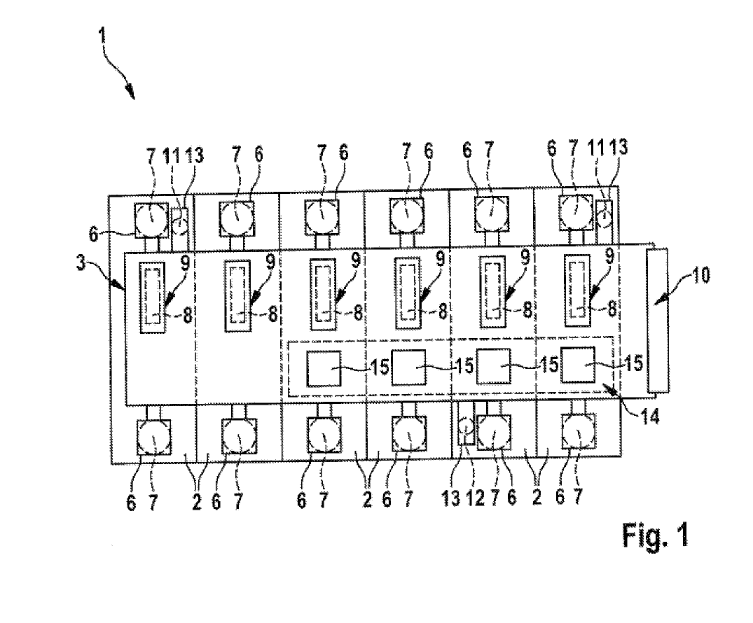

The battery system 1 illustrated in FIG. 1 comprises a plurality of battery cells 2. Said battery cells are in the form of prismatic battery cells with a metal cell housing and are arranged next to one another to form a battery module. Provision is made, in particular, for the battery cells 2 to be lithium-ion cells. The battery cells 2 each have two cell terminals 7 which are electrically conductively connected to the electrodes of the battery cells 2 (not explicitly illustrated in FIG. 1), and the battery cells 2 are electrically connected to one another via said cell terminals. Furthermore, the battery system 1 comprises a printed circuit board 3 which is in the form of a high-current printed circuit board. In this case, the printed circuit board 3 comprises at least one high-current line region and at least one low-current line region. In this case, the battery cells 2 of the battery system 1 are electrically connected to one another via the at least one high-current line region. To this end, the high-current line region of the printed circuit board 3 comprises cell connectors 6 which are partially integrated into the printed circuit board 3 via corresponding receiving regions (not explicitly illustrated in FIG. 1), and in the process partially project beyond the printed circuit board 3. In this case, the cell connectors 6 are welded to the cell terminals 7 of the battery cells 2 in an automated manner.

Furthermore, the battery system 1 illustrated in FIG. 1 comprises a battery management system 14 which is integrated into the printed circuit board 3. In this case, the battery management system 14 comprises cell monitoring units and at least one control unit which, as components 15 of the battery management system 14, are arranged on the printed circuit board 3 and are therefore integrated into said printed circuit board. Furthermore, the battery management system 14 of the battery system 1 comprises two temperature sensors 11 and one pressure sensor 12, which temperature sensors and pressure sensor are arranged on the battery cells 2 of the battery system 1. The sensors 11, 12 are in each case electrically conductively connected to the printed circuit board 3 via a connection lug 13. In this case, signals are guided to the components 15 of the battery management system 14 via the low-current line region of the printed circuit board 3. Provision is further made for the printed circuit board 3 to have an interface 10, preferably an interface which is in the form of part of a plug connection. A printed circuit board which is arranged above the battery cells of a further battery module can advantageously be connected via said interface 10.

The battery cells 2 of the battery system 1, which is illustrated in FIG. 1, furthermore have degassing openings 8 via which a gas which is formed as a result of critical heating of a battery cell 2 can escape from the cell housing of the respective battery cell 2 when a specific pressure threshold value is exceeded. In this case, the printed circuit board 3 has cutouts 9 which are in each case arranged above the degassing openings 8. As a result, the degassing openings 8 can advantageously be connected to a degassing device (not illustrated in FIG. 1), for example a degassing collector, via a connection element (not explicitly illustrated in FIG. 1) which is guided through the cutouts 9, so that a gas which is released from a battery cell 2 can be safely discharged via the degassing device.

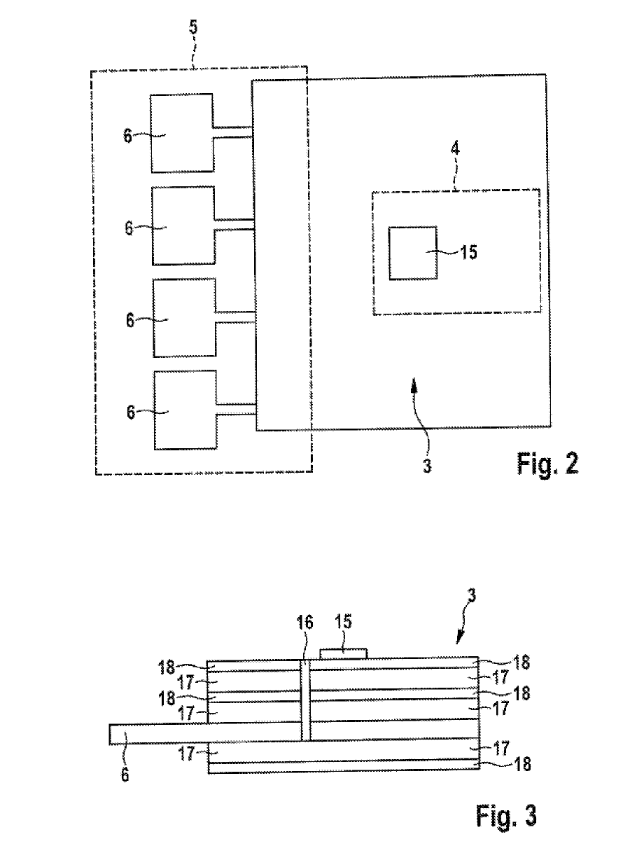

FIG. 2 shows, in a highly simplified manner, a printed circuit board 3 which is designed, in principle, for use with a battery system according to the invention. In this case, the printed circuit board 3 comprises at least one high-current line region 5 and at least one low-current line region 4. In this case, the printed circuit board 3 is preferably in the form of a high-current printed circuit board. In particular, the printed circuit board 3 is designed to electrically connect the battery cells of a battery system, which comprises a plurality of battery cells, to one another via the at least one high-current line region 5, and furthermore to electrically connect at least one battery cell of the battery system to a battery management system of the battery system via the at least one low-current line region 4, in particular in such a way that battery cell parameters which are detected by sensors can be transmitted to the battery management system. In this case, the battery management system is preferably at least partially integrated into the printed circuit board 3.

The high-current line region 5, illustrated in FIG. 2, of the printed circuit board 3 comprises cell connectors 6 via which the battery cells of a battery system can be electrically connected to one another. In this case, the cell connectors 6 are in the form of bent and stamped parts and project partially beyond the printed circuit board 3. In this case, that part of the cell connectors 6 which is not visible is integrated into the printed circuit board 3 via corresponding receiving regions (not explicitly illustrated in FIG. 2) in the printed circuit board 3. The cell connectors 6 are connected to one another via line elements (not explicitly illustrated in FIG. 2) of the high-voltage line region 5 of the printed circuit board 3, specifically in the same way as the battery cells with which contact is to be made by the cell connectors 6 later are intended to be connected to one another. The low-current line region 4 of the printed circuit board 3 comprises, in particular, components 15 of the battery management system of a battery system, in particular signal lines and/or cell monitoring units of the battery management system and/or the at least one control unit of the battery management system.

A lateral section through a printed circuit board 3 which is designed to be used with a battery system according to the invention is shown in a highly simplified manner in FIG. 3. In this case, the printed circuit board 3 is in the form of a high-current printed circuit board. As shown in FIG. 3, the printed circuit board 3 is of layered design in this case, wherein the printed circuit board 3 comprises, in particular, regions comprising a carrier material 17, in particular comprising a mixture of epoxy resin and glass fiber fabric (also called “FR4”). Furthermore, the printed circuit board 3 comprises conductor tracks 18 which are preferably composed of copper. Furthermore, the printed circuit board 3, in the exemplary embodiment illustrated in FIG. 3, comprises at least one cell connector 6 which is inserted into a corresponding receiving region of the printed circuit board 3 and projects beyond the printed circuit board 3. Electrically conductive contact is made with the cell terminal of a battery cell via a cell connector 6 of this kind, in particular by welding the cell connector 6 to the cell terminal of a battery cell of the battery system.

Electrical connection of line elements 6, 18 of the printed circuit board 3 can be performed, in particular, via plated-through holes 16 in the printed circuit board 3. Provision is made, in particular, for the components of the high-current line region of the printed circuit board 3, in particular the cell connectors 6, to have a cross-sectional area of at least 20 mm2. Furthermore, provision is made, in particular, for the high-current line regions to be designed to conduct currents of up to 1000 A and above, in particular without the printed circuit board 3 or components of the printed circuit board 3 being damaged. Furthermore, provision is made, in particular, for power and/or control electronics of the battery system, with which the printed circuit board 3 is used, to be integrated into the printed circuit board 3. By way of example, a component 15 of the battery management system is mounted onto the printed circuit board 3 for this purpose. The electrically conductive connection of said component 15 to a battery cell of the battery system which is to be connected to the printed circuit board 3 is preferably performed via the low-current line region of the printed circuit board 3 in this case.

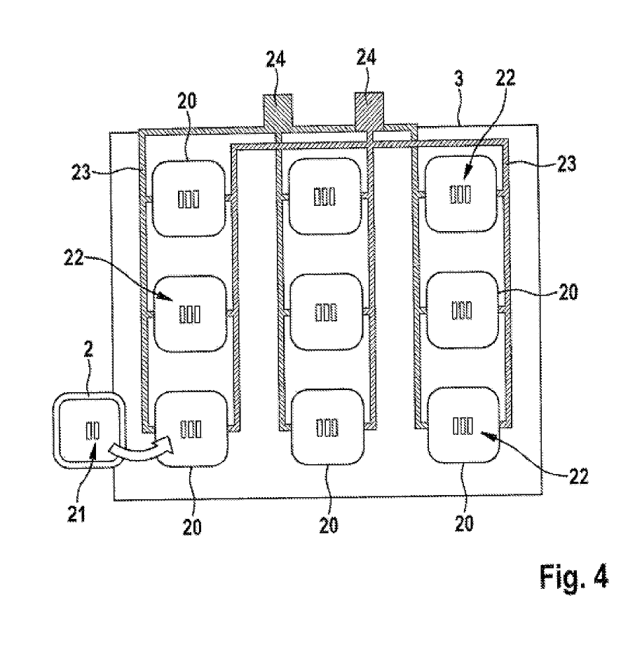

FIG. 4 shows a further particularly advantageous refinement of a printed circuit board 3 for use with a battery system according to the invention. In this case, the printed circuit board 3 has a plurality of contact-making elements 22. Said contact-making elements 22 can be in the form of, in particular, contact lugs or contact pins. In this case, the contact-making elements 22 are connected to one another via line elements 23, by conductor tracks in FIG. 4. In this case, provision is made for the battery cells 2 of a battery system according to the invention, which battery cells likewise have corresponding contact-making elements 21, to be arranged on the contact-making elements 22 by way of the contact-making elements 21 (symbolically illustrated by the curved arrow in FIG. 4). In this case, the battery cells 2 are advantageously connected to the at least one high-current region via the contact-making elements 22. In this case, the connection of the contact-making elements 22 to one another determines the connection of the battery cells 2 which are arranged on the contact-making elements 22. In the exemplary embodiment illustrated in FIG. 4, the battery cells 2 are electrically connected in parallel in this case.

As illustrated in FIG. 4, the contact-making elements 22 of the printed circuit board 3 are preferably arranged in special receiving regions 20. In this case, the receiving regions 20 of the printed circuit board 3 can be in the form of, in particular, indentations in the printed circuit board 3 into which the battery cells 2 can be at least partially inserted, preferably in an interlocking manner. Provision is made, in particular, for the indentations to be able to be designed to be 1 mm to several centimeters, for example 3 cm, deep.

The contact-making elements 21 of a battery cell 2 form the respective contact-making pairs with the contact-making elements 22 of a receiving region 20 of the printed circuit board 3, wherein the contact-making elements 21, 22 are advantageously designed in such a way that a contact-making pair is connected in a force-fitting manner.

The battery cell voltage of the battery cells which are arranged on the printed circuit board 3 via the contact-making pairs can be tapped off via connection contacts 24 of the printed circuit board 3. In this case, said battery cell arrangement may be a subunit of a battery system according to the invention and be electrically connected to further subunits.

Provision is made, in particular, for sensors for detecting battery cell parameters of battery cells 2, in particular temperature and/or current sensors, to be integrated into the printed circuit board 3 (not explicitly illustrated in FIG. 4). Furthermore, the battery management system can, in particular, also be entirely or partially integrated into the printed circuit board 3. Provision is made, in particular, for components of the battery management system, in particular cell monitoring units, to be integrated into the printed circuit board 3.

The printed circuit board 3 is advantageously designed in the manner of a cover which is to be arranged on battery cells 2.

The exemplary embodiments illustrated in the figures and explained in connection with said figures serve to explain the invention and do not limit said invention.

What is claimed is:

1. A battery system (1) having a plurality of battery cells (2) and a battery management system (14) for monitoring and regulating the battery system (1), wherein the battery cells (2) are electrically connected to one another, and at least one battery cell (2) of the battery system (1) is electrically connected to the battery management system (14) in order to detect at least one battery cell parameter, characterized in that the battery system (1) comprises at least one printed circuit board (3) having at least one high-current line region (5) and at least one low-current line region (4), wherein the battery cells (2) are electrically connected to one another via the at least one high-current line region (5), and the at least one battery cell (2) is electrically connected to the battery management system (14) via the at least one low-current line region (4).

2. The battery system (1) according to claim 1, characterized in that the printed circuit board (3) has contact-making elements (22) which are electrically connected to one another and on which the battery cells (2) are arranged, wherein the battery cells (2) are in each case connected to at least one of the at least one high-current line region (5) and the at least one low-current line region (4) via the contact-making elements (22).

3. The battery system (1) according to claim 2, characterized in that the printed circuit board (3) has receiving regions (20) in which the contact-making elements (22) are arranged in each case, wherein the battery cells (2) are in each case inserted at least partially into the receiving regions (20).

4. The battery system (1) according to claim 1, characterized in that the at least one printed circuit board (3) is a high-current printed circuit board.

5. The battery system (1) according to claim 1, characterized in that the at least one high-current line region (5) comprises cell connectors (6), wherein the battery cells (2) are electrically connected to one another by means of the cell connectors (6).

6. The battery system (1) according to claim 1, characterized in that the battery cells (2) are electrically connected to one another to form at least one battery module, wherein the at least one printed circuit board (3) is arranged on the at least one battery module.

7. The battery system (1) according to claim 1, characterized in that the battery management system (14) is at least partially integrated into the at least one printed circuit board (3).

8. The battery system (1) according to claim 1, characterized in that the battery management system (14) comprises at least one cell monitoring unit, wherein the at least one cell monitoring unit is integrated into the at least one printed circuit board (3).

9. The battery system (1) according to claim 1, characterized in that the battery management system (14) comprises at least one control unit, wherein the at least one control unit is integrated into the at least one printed circuit board (3).

10. The battery system (1) according to claim 1, characterized in that the battery management system (14) comprises at least one sensor (11, 12) for detecting at least one battery cell parameter, wherein the at least one sensor (11, 12) is integrated into the at least one printed circuit board (3).

11. The battery system (1) according to claim 1, characterized in that the at least one printed circuit board (3) comprises at least one interface (10) for making electrically conductive contact with at least one of the at least one high-current line region (5) and the at least one low-current line region (4).

12. The battery system (1) according to claim 1, characterized in that the battery system (1) comprises a degassing device for discharging a fluid which is released by a battery cell (2) of the battery system (1), and battery cells (2) of the battery system (1) are connected to the degassing device via connection elements, wherein the at least one printed circuit board (3) has cutouts (9) through which the connection elements are guided.

13. The battery system (1) according to claim 2, characterized in that the printed circuit board (3) has contact-making elements (22) which are electrically connected to one another and on which the battery cells (2) are arranged, wherein the battery cells (2) are in each case connected to both of the at least one high-current line region (5) and the at least one low-current line region (4) via the contact-making elements (22).

14. The battery system (1) according to claim 11, characterized in that the at least one printed circuit board (3) comprises at least one interface (10) for making electrically conductive contact with both of the at least one high-current line region (5) and the at least one low-current line region (4).
